(19) United States
(12) Patent Application Publication
(10) Pub. No.: US 2009/0078093 A1
(43) Pub. Date: Mar. 26, 2009

(54) Universal socket adapter

(76) Inventors: Joseph A. Suski, JR., Bridgeview, IL (US); Viola Rose Suski, Bridgeview, IL (US); Russell J. Tlapa, Bedford Park, IL (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/071,677

(22) Filed: Feb. 25, 2008

Related U.S. Application Data
(60) Provisional application No. 60/960,281, filed on Sep. 24, 2007.

(51) Int. Cl. B25B 13/06

(52) U.S. Cl. 81/121.1

(57) ABSTRACT

The universal socket adapter is a multitiered drive adapter that can be attached to the head of a drive, such as a ratchet drive. The adapter has an upper socket stop at the female end for stopping upward axial travel of a socket mated to the uppermost drive tier of the tool. The upper socket stop has a drive-receiving bore adapted for accepting the drive of a driver tool, such as a ratchet drive. A plurality of drive tiers are integrally formed and extend away from the upper socket stop to form the male end of the adapter. Each adapter drive tier is successively smaller than the one above it. All of the drives are disposed concentrically below the upper socket stop so that each drive tier can accommodate a corresponding drive-size socket.

### CROSS-REFERENCE TO RELATED APPLICATION

This application claims the benefit of U.S. Provisional Patent Application Ser. No. 60/960,281, filed Sep. 24, 2007.

### BACKGROUND OF THE INVENTION

1. Field of the Invention

The present invention relates generally to tools, and more particularly to a universal socket adapter for use with hand and power tools.

2. Description of the Related Art

Socket wrenches are commonly used because of the speed and convenience of a ratchet drive. Socket sets that include a ratchet and sockets of various sizes are commonly available with ¼″, ⅜″, ½″, and ¾″ drives, and specialty socket sets with even larger drives are also available in order to adjust the torque applied to the fastener. Sometimes, however, the mechanic will need a socket for a bolt or other fastener that is not available for the ratchet provided with his own socket set, but is available for the next larger or smaller drive size. Instead of buying an entire new socket set, the mechanic may buy the single socket needed for the task at hand and an adapter that enables the mechanic to use his ratchet with sockets made for the next larger or smaller drive size. For example, an adapter is available that reduces the drive size so that a ¼″ drive socket may be used with a ⅜″ drive ratchet. Another adapter is available that increases the drive size so that a ½″ drive socket may be used with a ⅜″ drive ratchet.

However, no single adapter is available that can both increase and reduce the drive size, or that can increase or reduce the drive size for multiple sizes. Consequently, the mechanic typically has to have multiple adapters on hand to use a single ratchet drive with multiple drive-size sockets. It is commonplace for the mechanic's toolbox and workplace to become disorganized, so that the mechanic often loses time searching for the proper size of adapter for the task at hand. The same problem may arise with pneumatic, electric, or other power tool wrenches, ratchets, or drivers in order to adapt the power tool wrench, ratchet or driver for use with sockets of different drive size.

Thus, a universal socket adapter solving the aforementioned problems is desired.

### SUMMARY OF THE INVENTION

The universal socket adapter is a multitiered drive adapter that can be attached to the head of a drive, such as a ratchet drive. The adapter has an upper socket stop at the female end for stopping upward axial travel of a socket mated to the uppermost tier of the tool. The upper socket stop has a drive-receiving bore adapted for accepting the drive of a driver tool, such as a ratchet drive. A plurality of tiers of drives are integrally formed and extend away from the upper socket stop to form the male end of the adapter. Each adapter drive tier is successively smaller than the one above it. All of the drives are disposed concentrically below the upper socket stop so that each drive tier can accommodate a corresponding drive-size socket.

These and other features of the present invention will become readily apparent upon further review of the following specification and drawings.

### BRIEF DESCRIPTION OF THE DRAWINGS

FIG. 1 is an environmental perspective view of a universal socket adapter according to the present invention.

FIG. 2 is an axial section view of a universal socket adapter according to the present invention.

FIG. 3 is a perspective view of an alternative embodiment of a universal socket adapter according to the present invention having a knurled stop.

FIG. 4 is an axial section view of another alternative embodiment of a universal socket adapter according to the present invention incorporating an extension bar.

FIG. 5 is a perspective view of another embodiment of a universal socket adapter according to the present invention having a hex shank for attachment to an electric drill.

FIG. 6 is an axial section view of the universal socket adapter of FIG. 5.

FIG. 7 is a front view of a kit of universal socket adapters according to the present invention.

Similar reference characters denote corresponding features consistently throughout the attached drawings.

### DETAILED DESCRIPTION OF THE PREFERRED EMBODIMENTS

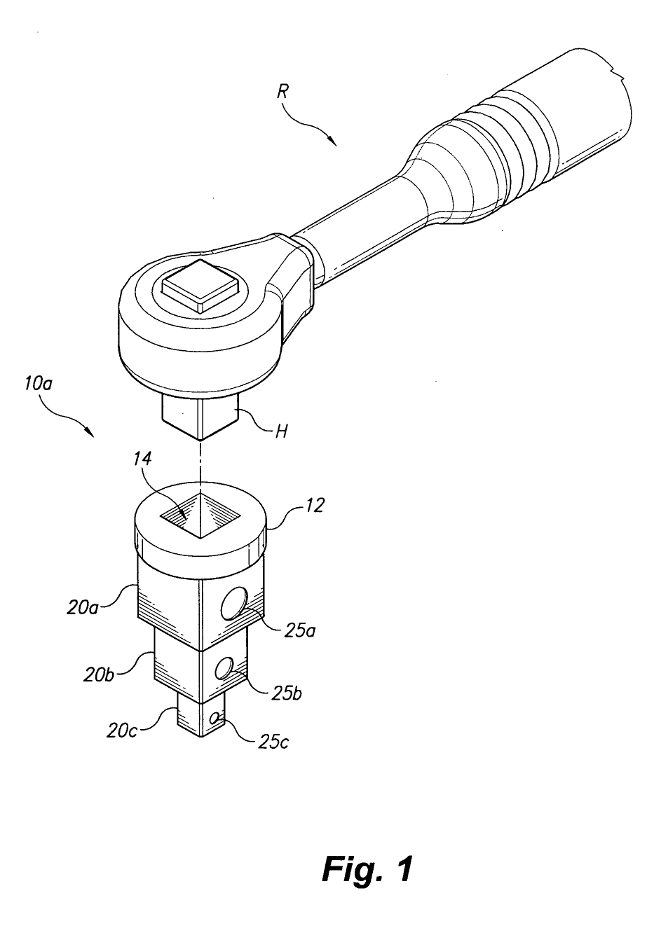

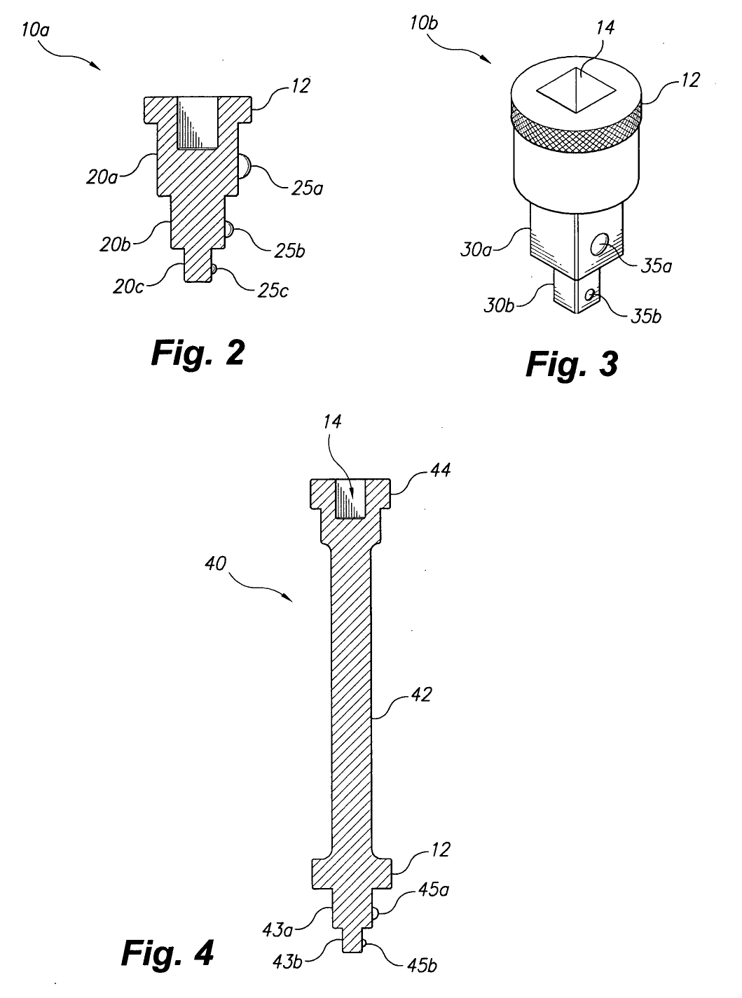

As shown in FIGS. 1-2, a first embodiment of the present invention is a multitiered drive adapter 10a that can be attached to the head H or drive of a driver, such as ratchet drive R. Adapter 10a is shown in section in FIG. 2. Adapter 10a has an upper socket stop 12 at the female end of the adapter 10a. The stop 12 is a planar surface capable of stopping upward axial travel of a mated socket to the uppermost tier 20a of the tool 10a. Upper socket stop 12 has a drive-receiving bore 14 adapted for accepting the drive of a driver tool, such as ratchet drive R. The drive-receiving bore 14 is defined by a plurality of sides, and may be square in cross section, as shown in FIG. 1. Drive-receiving bore 14 is dimensioned to seat the drive of ratchet drive R therein.

At the male end of the adapter, a plurality of tiers of drives 20a, 20b and 20c are integrally formed and concentrically extend away from upper socket stop 12. As illustrated in FIGS. 1 and 2, the three tiers of drives of adapter 10a decrease in size as they concentrically extend away from the upper socket stop 12. Drive 20a is larger than drive 20b, and drive 20b is larger than drive 20c. The exemplary tiers shown in FIG. 2 are solid square drives, although other drive shapes are within the scope of the invention. The sizes of the drives in the respective tiers depend upon the desired application of the tool.

For example, if drive-receiving bore 14 is dimensioned for a ¼ inch drive, then preferably drive 20a is dimensioned to receive a ¾″ drive socket, drive 20b is dimensioned to receive a ½″ drive socket, and drive 20c is dimensioned to receive a ⅜″ drive socket. Similarly, if drive-receiving bore 14 is dimensioned for a ⅜″ drive, then preferably drive 20a is dimensioned to receive a ¾″ socket, drive 20b is dimensioned to receive a ½″ drive socket, and drive 20c is dimensioned to receive a ¼″ drive socket. It should be noted that the above dimensions are representative, and the scope of the invention extends an adapter having any practical and useful combination of drive sizes, as well as any practical number of tiers.

Drive 20a has a spring-biased detent ball 25a recessed in a cavity defined therein that protrudes from an aperture defined in one of the walls of the drive 20a. Additionally, drive 20b has an appropriately sized spring-biased detent ball 25b recessed in a cavity thereof. Similarly, drive 20c has an appropriately sized spring-biased detent ball 25c recessed in a cavity thereof. Spring-biased detent balls 25a, 25b, and 25c are provided to lock an appropriately sized socket onto a respective one of the drives 20a, 20b and 20c. Bottom surfaces of drives 20a and 20b respectively form a shoulder or socket stop for successively smaller tiers disposed below. Adapter 10a functions to accommodate the size of drive H to the drive size of the socket. Exemplary plurality of tiers of drives 20a, 20b, and 20c allow use of both larger and smaller sockets than the drive of tool R can accommodate alone. Thus, adapter 10a allows a conventional socket wrench drive handle, or a conventional air ratchet drive or other power tool, to accommodate a wide range of socket sizes.

As shown in FIG. 3, an alternative embodiment is provided having only two tiers defined by drives 30a and 30b, with respective detent balls 35a and 35b. If drive-receiving bore 14 is dimensioned for a ⅜″ drive, then preferably drive 30a is dimensioned to receive a ½″ drive socket and drive 30b is dimensioned to receive a ¼″ drive socket. Moreover, a portion of the upper socket stop 12 of the adapter 10b may have a knurled outer surface.

As shown in FIG. 4, in yet another embodiment, adapter 40 has an elongated extension bar shank 42 between the female end and the male end of the adapter 40. In the embodiment shown, at the male end drives 43a and 43b extend from upper socket stop 12 and have respective ball detents 45a and 45b. Drive-receiving bore 46 of adapter 40 is dimensioned to receive a ⅜″ drive. Drive 43a is dimensioned to receive a ½″ drive socket, and drive 43b is dimensioned to receive a ¼″ drive socket. Top flange 44 at the female end of adapter 40 and upper socket stop 12 at the male end of adapter 40 may each have a knurled outer surface to facilitate a user's grip during handling, socket attachment, socket detachment, or the like.

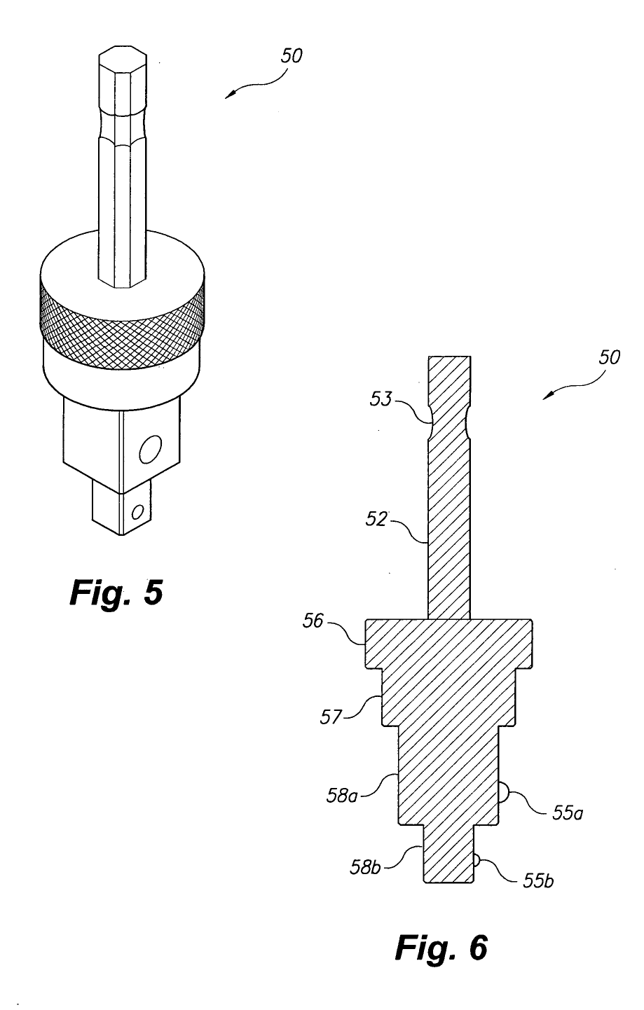

As shown in FIGS. 5 and 6, in a further embodiment of the present invention, adapter 50 is provided having a drill bit attachment shank 52. Drill chuck bit 53 is provided for removable attachment to a chuck of a power drill. In the embodiment shown, drives 58a and 58b extend from socket stop 57 and have respective detent balls 55a and 55b. Drill bit attachment shank 52 may be of hexagonal design and of any predetermined length. Preferably, drive 58a is dimensioned to receive a ¾″ drive socket, and drive 58b is dimensioned to receive a ⅜″ drive socket. The adapter 50 has an upper socket stop 57 extending from overhanging annular chuck stop 56.

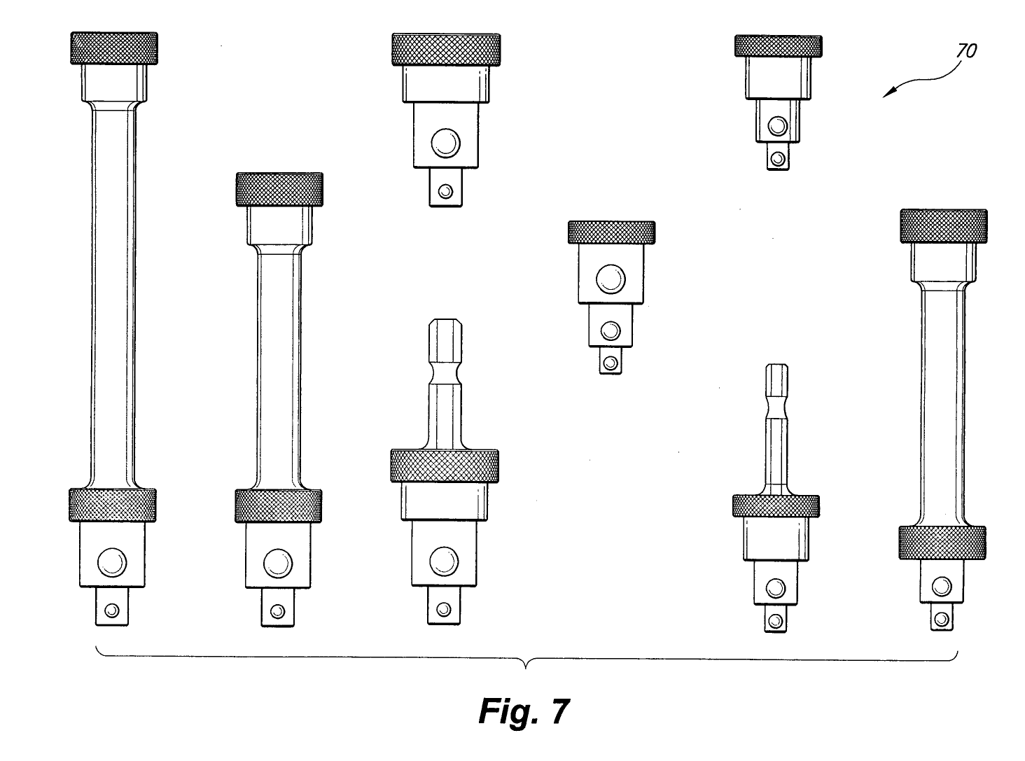

As shown in FIG. 7, a kit 70 of adapters may be provided. The kit 70 may include adapters having a variety of number of drive tiers, a variety of unitary shank attachments, and a variety of drill chuck shank attachments having different lengths and diameters.

It is to be understood that the present invention is not limited to the embodiments described above, but encompasses any and all embodiments within the scope of the following claims.

1. A universal socket adapter, comprising:
a body having a male end and a female end, the female end having planar upper and lower surfaces and a drive-receiving bore defined therein adapted for receiving a drive of a driver tool, wherein the female end of the adapter includes an upper socket stop, the upper socket stop having a planar surface, the planar surface stopping upward axial travel of a mated socket to the uppermost tier of the adapter; and
a plurality of successively smaller tiers of drives forming the male end of the body, each of said tiers being contiguous and extending away from the female end, the drives being adapted for attaching a corresponding drive-size socket to the adapter, wherein the largest of said tiers is contiguous to said lower planar surface of said female end and said drive-receiving bore extends into said largest tier a sufficient distance to load and anchor a drive of a driver tool;
whereby a single adapter is adapted to be used to alternately attach sockets of different drive size to the driver tool.

2. The universal socket adapter according to claim 1, wherein the drive receiving bore is square in cross section.

3. (canceled)

4. The universal socket adapter according to claim 1, wherein the socket stop is an annular ring, the drive receiving bore extending therefrom.

5. The universal socket adapter according to claim 1, wherein the peripheral edge of the socket stop has a knurled finish for handling by a user.

6. The universal socket adapter according to claim 1, wherein the tiered drives have square cross sections.

7. The universal socket adapter according to claim 1, wherein each drive has a cavity defining an aperture in one of the walls of the drive, the universal socket adapter further comprising a spring-biased detent ball recessed in the cavity, the detent ball having a portion protruding through the wall aperture to lock an appropriately sized socket onto the drive.

8. The universal socket adapter according to claim 1, further comprising an elongated extension bar shank disposed between the female end and the male end of the adapter.

9. The universal socket adapter according to claim 8, further comprising a knurled pattern disposed on an outer portion of the adapter female end to facilitate a user's grip during handling.

10-15. (canceled)
